(19) United States
(12) Patent Application Publication
(10) Pub. No.: US 2007/0035816 A1
(43) Pub. Date: Feb. 15, 2007

(54) Method of manufacturing a semiconductor device having a porous dielectric layer and air gaps

(76) Inventors: Roel Daamen, Eindhoven (NL); Greja Johanna Adriana Maria Verheijden, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/557,767

(22) PCT Filed: May 17, 2004
(86) PCT No.: PCT/IB04/50715

§ 371 Date: Nov. 17, 2005

(30) Foreign Application Priority Data
May 26, 2003 (EP) 0310507.6

(51) Int. Cl. F21V 9/04

(52) U.S. Cl. 359/360

(57) ABSTRACT

A method to produce air gaps between metal lines (8(i)( and within dielectrics. The method consists of obtaining a dual damascene structure, applying a diffusion barrier layer (10) directly on the planarized surface and performing a lithography step, thus shielding the metal lines underneath the diffusion barrier layer. Optionally, some portions of large dielectric areas (6) between the metal lines (8(i)) are also shielded. The exposed diffusion barrier layer portions and underlying dielectric are etched. A layer of a material that can be decomposed in volatile components by heating to a temperature of typically between 150-450° C. is applied and planarized by etching or CMP. A dielectric layer (20) that is permeable to the decomposition products is deposited and subsequently the substrate is heated. Then, the disposable layer decomposes and disappears through the permeable dielectric layer, leaving air gaps (22) behind in between the metal lines (8(i)) and the large dielectric areas.

The present invention relates to a method of manufacturing a substrate, comprising the provision of a dual damascene structure on the substrate, which comprises a metal layer on which a first dielectric layer provided with a via is present, a second dielectric layer disposed on the first dielectric layer and provided with an interconnect groove, in which via and in which interconnect groove a metal is present which forms a metal line having an upper side. In a later process step, the second dielectric layer is removed and air gaps are provided in the space earlier occupied by the second dielectric layer to reduce the capacitance between adjacent metal lines.

Such a method is known from WO 02/19416. To better understand the invention, FIG. 1 shows the result of the method according to WO 02/19416.

FIG. 1 shows a dual damascene structure on a semiconductor device. The structure comprises a metal layer 1 within a dielectric layer. A dielectric layer 2 is provided on the metal layer 1. The dielectric layer 2 comprises a via 5 that is filed with a metal. The metal also extends on top of the dielectric layer 2 and forms a metal line 8. On top of the dielectric 2, a patterned hard mask 4 may be provided that is used to produce the via 5 as is explained in detail in WO 02/19416.

The structure comprises a porous dielectric layer 20 that is supported by the metal line 8. Between the porous dielectric layer and the dielectric layer, air gaps 22 are provided. The air gaps 22 are produced by removal of a planarized disposable layer through the porous dielectric layer, which disposable layer has been deposited on the structure before the porous dielectric layer 20 was deposited. The disposable layer may be a polymer that can be removed by a combined curing and baking step, e.g., at 400° C. Due to the heating the polymer is decomposed and evaporates through the porous dielectric layer 20 as is indicated with arrows 15.

As can be seen from FIG. 1, a copper diffusion barrier 11 covers the metal line 8 and is present at the bottom and side walls of the air gaps 22. The copper diffusion barrier 11 is produced in an intermediate step in the method according to the prior art and prevents diffusion of copper ions from metal line 8 to other layers present on top of the structure shown in FIG. 1. Such a diffusion of copper ions from metal line 8 may result in shorts in other dielectric layers. However, since the copper diffusion barrier 11 having a relatively high k-value within the air gaps 22 takes up some volume of the air gap space 22, the overall capacitance is not optimal, thus limiting the capacitance reduction by air gaps.

Therefore, it is a primary objective of the present invention to provide a substrate as known from the prior art, in which, however, the air gaps can be made with a larger volume so as to further reduce the capacitance between adjacent metal lines.

In order to achieve this objective, the method according to the invention, as defined at the outset, comprises:
(a) deposition of a diffusion barrier layer on top of the second dielectric layer and the upper side of the metal line;
(b) removing predetermined portions of the second dielectric layer and the diffusion barrier layer while leaving intact the diffusion barrier layer located on the upper side of the metal line;
(c) provision of a decomposable layer on the first dielectric layer and portions of the diffusion barrier layer left intact;
(d) planarizing the decomposable layer substantially down to the portions of the barrier layer left intact;
(e) provision of a porous dielectric layer on the decomposable layer; and
(f) removal of the decomposable layer through the porous dielectric layer so as to form at least one air gap.

Thus, by using an additional mask operation, the structure can be manufactured such that the diffusion barrier layer is substantially only present on top of the metal line. The air gaps are substantially free of the diffusion barrier layer. Therefore, the volume of the air gaps can be made larger, thus further reducing the capacitance between adjacent metal lines.

It is observed that the step defined in (d) may comprise planarizing the decomposable layer such that its upper surface is below the upper surface of the barrier layer, potentially even as low as the upper surface of the metal line.

A further objective of the present invention, in an embodiment, is to prevent sagging of the porous dielectric layer above wide air gaps.

To achieve this objective, the invention provides, in an embodiment, that in phase (b), at least one other portion of the second dielectric layer and the diffusion barrier layer is left intact so as to form at least one support structure within the air gaps.

In a further embodiment, the invention provides a substrate with a dual damascene structure provided thereon, comprising a metal layer on which a dielectric layer provided with a via is present, a metal line partly extending on a top surface of the dielectric layer and partly extending in the via, a diffusion barrier layer on an external surface of the metal line, a porous dielectric layer supported by at least the metal line and defining at least one air gap between the porous dielectric layer and the dielectric layer, characterized in that the diffusion barrier layer covers substantially only a top surface of the metal line.

This substrate has the advantages as listed above for the method according to the invention.

Such a substrate may have at least one air gap comprising at least one support structure to further support the diffusion barrier layer.

Finally, the invention relates to a semiconductor device that comprises a substrate as defined above.

The invention will now be further explained with reference to some drawings, which are only intended to illustrate the invention and not to limit the scope of the invention.

The scope of the invention is only limited by the claims annexed to this description and all equivalences for the features claimed.

FIG. 1 shows a dual damascene structure according to the prior art.

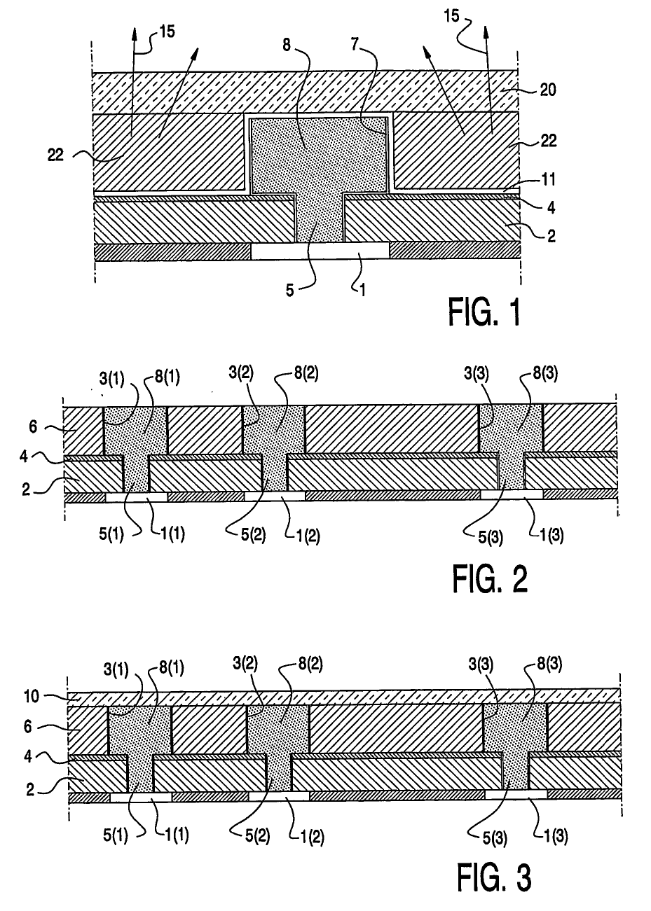

FIGS. 2 through 9 show several steps to produce an alternative structure for the structure shown in FIG. 1.

FIG. 2 shows a dual damascene structure. This structure was manufactured in a known manner (for example, see WO-A-00/19523) and comprises one or more metal layers 1(i), (i=1, 2, . . . ). A first dielectric layer 2 is present on the metal layers 1(i). This layer 2 preferably comprises a low-k dielectric, such as a micelle templated, permeable organosilicate or a polyarylene ether, such as, for example, SILK® (Dow Chemical). The metal layers 1(i) are obtained in a dielectric layer, which is not of further relevance to the present invention. A patterned hard mask 4 is provided on the first dielectric layer 2.

The hard mask 4 comprises, for example, SiC or Si₃N₄ and serves as an etch stop layer. A second dielectric layer 6 is provided on the etch stop layer 4. The second dielectric layer 6 preferably comprises an oxide, which is easy to apply and to remove, such as SOG or Nanoglass® (Allied), but may alternatively comprise a polymer, such as SiLK. Also, a CVD-type oxide may be used.

Grooves 3(i) and vias 5(i) are etched in the second and the first dielectric layer 6 and 2, respectively, by means of a hard mask (not shown) on the second dielectric layer 6 and the patterned etch stop layer 4 between the second and the first dielectric layer 6 and 2. It is possible to form such a structure without the use of the etch stop layer 4, provided the second and the first dielectric layer 6 and 2 can be selectively etched relative to one another. Grooves 3(i) and vias 5(i) are subsequently filled with a metal, whereby metal lines 8(i) are formed. Grooves 3(i) and vias 5(i) with metal lines 8(i) form the dual damascene structure, on which a, e.g., TaN barrier line and a subsequent Cu seed layer are deposited. The method according to the invention is particularly useful in a process in which copper is used as the metal for metal lines 8(i). The metal lines 8(i) are used for interconnecting purposes, as is known to persons skilled in the art. Instead of copper, other metals like aluminum may be used.

After the grooves 3(i) and the vias 5(i) have been filled by means of, e.g., Cu electroplating or electroless Cu deposition, the copper is planarized in a usual manner, (e.g., by using CMP). The metal lines 8(i) are provided with an upper side in this manner.

FIG. 3 shows a next step in the process of manufacturing a substrate in accordance with the invention. A diffusion barrier layer 10 is applied to the structure shown in FIG. 2. The diffusion barrier layer 10 may be made of, e.g., SiC, Si₃N₄. However, other suitable materials are possible.

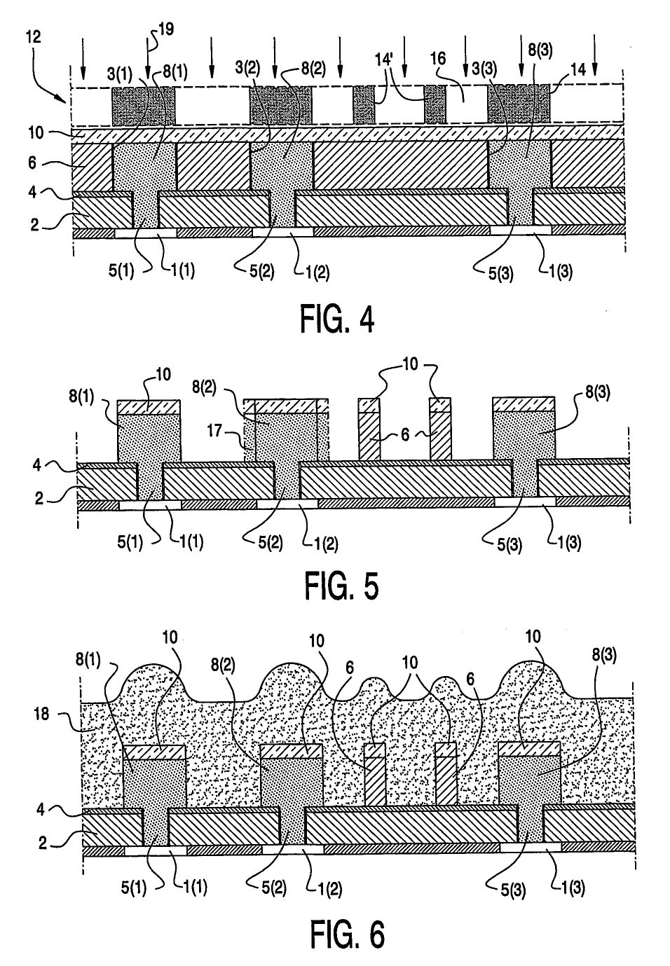

Then, in FIG. 4, a lithography step is performed. I.e., a mask 12 is used with first portions 14 that are not transmissive to a predetermined radiation 19 and other portions 16 that are transmissive to the radiation 19. The mask 12 is arranged such that the radiation 19 is unable to impinge on the metal lines 8(i). Moreover, optionally, there may be provided additional portions 14′ in the mask 12 that prevent the radiation 19 from impinging upon predetermined portions of the second dielectric layer 6.

As shown in FIG. 5, the exposed parts of the diffusion barrier layer 10 and of the second dielectric layer 6 are etched and, potentially, stripped to the bottom of the second dielectric layer 6. If etch stop layer 4 is present, this bottom coincides with said etch stop layer 4. However, if etch stop layer 4 is not applied, this bottom coincides with the upper surface of the first dielectric layer 2.

Optionally, some first portions 14 of mask 12 are wider than corresponding metal lines 8(i). Then, side wall supports 17, indicated with dashed lines in FIG. 5, comprising material of the second dielectric layer 6 and a portion of the diffusion barrier layer 10, may be left intact. These side wall supports 17 may, later, provide the same functionality as portions 6 of the second dielectric layer not etched away in this step.

FIG. 6 shows that, in a next step, a layer of decomposable material 18 is provided on top of the structure of FIG. 5. This layer of decomposable material 18 may be applied by using a spin process. The decomposable material 18 is, e.g., decomposed in volatile components by heating to a temperature of typically 150-450° C. This decomposable material may be, e.g., a resist, a PMMA (polymethyl methacrylate), polystyrene, or polyvinyl alcohol, or another suitable polymer. The resist may be a UV photoresist.

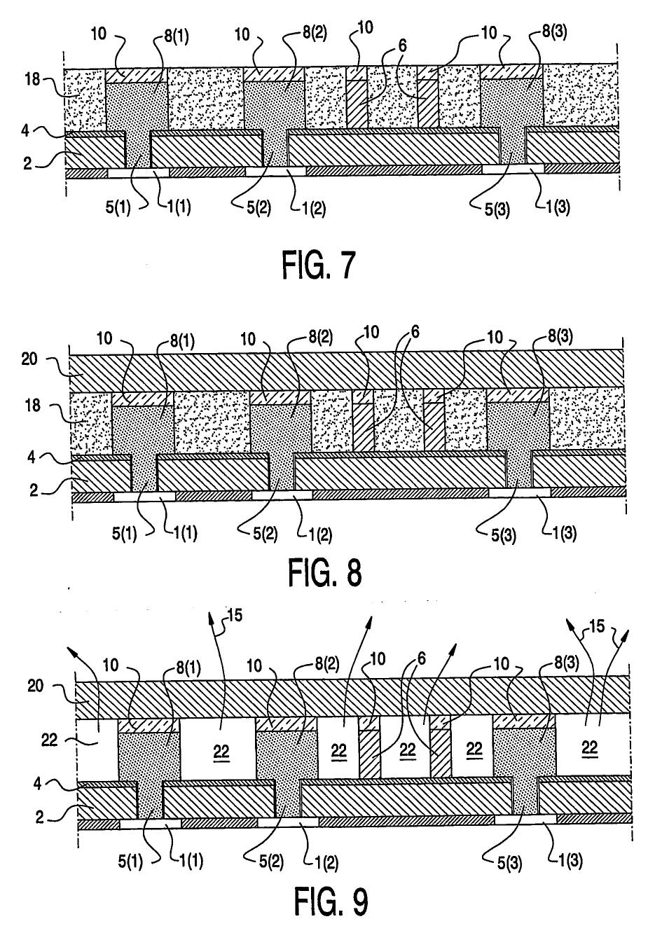

FIG. 7 shows the device after planarization of the decomposable material layer 18. If a polymer was used as the air gap material, this planarization may take place by etching back the polymer in a suitable dry etch plasma or by polishing back until the non-conductive barrier layer 10 becomes exposed at the upper side of the metal lines 8(i). Alternatively, the decomposable layer 18 may be planarized to a level just below the upper surface of barrier layer 10 or even as low as the upper surface of metal line 8(i).

In FIG. 8, a porous dielectric layer 20 is provided on the decomposable material layer 18 and the non-conductive barrier layer 10. The porous dielectric layer 20 preferably comprises a low-k permeable dielectric, such as SILK, provided in a spin coating process. A plasma CVD (chemical vapour deposition) layer may also be used as the porous dielectric layer 20 if deposition can take place below the decomposition temperature of layer 18.

FIG. 9 shows a device manufactured by a method according to the invention. Air gaps 22 have been created next to metal lines 8(i). If a polymer was used for the decomposable material layer 18, the air gaps 22 may be obtained through a combined curing and baking process, preferably at 400° C. The air gap polymer is decomposed as a result of the heating, and the air gaps 22 are created below the porous dielectric layer 20. The creation of the air gaps 22 is symbolically depicted by the arrows 15. The porous dielectric layer 20 comprising SiLK can be spun on without problems to a thickness which corresponds to the height of the vias 5(i) in the dual damascene structure 20, for example 0.5 μm. SiLK at this thickness is still sufficiently permeable for the removal of all the polymeric material of decomposable material layer 18.

A plurality of similar structures may be provided on the structure shown in FIG. 9. Metal lines in the structures above the structure of FIG. 9 may, then, contact one or more of the metal lines 8(i) by means of vias.

Thus, the structure according to FIG. 9 only comprises diffusion barrier layer 10 on top of the metal lines 8(i). There is no diffusion barrier material present anymore within the gaps 22. Thus, more effective airspace is provided and the capacitance between adjacent metal lines 8(i) can be further reduced.

Moreover, the lithography step of FIG. 4 provides for the option to define portions of the second dielectric layer 6 to remain intact within the air gaps. These preserved portions of the second dielectric layer 6, together with portions of the diffusion barrier layer 10 on top of them, have a well defined height and support the porous dielectric layer 20 in order to prevent this porous dielectric layer 20 from sagging in air gaps 22 of a relatively large size. The preserved portions of the second dielectric layer 6 may have any suitable cross-section, e.g., circular, rectangular, etc.

1. A method of manufacturing a substrate, comprising
providing a dual damascene structure on said substrate, the substrate including a metal layer, on the metal layer, a first dielectric layer having a via is present, a second dielectric layer disposed on the first dielectric layer and the second dielectric provided with an interconnect groove, in said via and in said interconnect groove a metal is present forming a metal line having an upper side, the method comprising:
(a) deposition of a diffusion barrier layer on top of the second dielectric layer and the upper side of the metal line;
(b) removing predetermined portions of the second dielectric layer and the diffusion barrier layer while leaving intact the diffusion barrier layer located on the upper side of the metal line;
(c) provision of a decomposable layer on the first dielectric layer and portions of the diffusion barrier layer left intact;
(d) planarizing the decomposable layer substantially down to the portions of the barrier layer left intact;
(e) provision of a porous dielectric layer on the decomposable layer; and
(f) removal of the decomposable layer through the porous dielectric layer so as to form at least one air gap.

2. Method according to claim 1, wherein an etch stop layer is provided between the first dielectric layer and the second dielectric layer.

3. Method according to claim 1, wherein the metal used is Cu.

4. Method according to claim 1, wherein, in phase (b) at least one other portion of said second dielectric layer and said diffusion barrier layer is left intact so as to form at least one support structure within said air gaps.

5. Method according to claim 1, wherein said substrate is a semiconductor device.

6. A substrate with a dual damascene structure provided thereon, comprising:
a metal layer on which a dielectric layer provided with a via is present,
a metal line partly extending on a top surface of said dielectric layer and partly extending in said via,
a diffusion barrier layer on an external surface of the metal line,
a porous dielectric layer supported by at least said metal line and defining at least one air gap between said porous dielectric layer and said dielectric layer, characterized in that said diffusion barrier layer covers substantially only a top surface of said metal line.

7. Substrate according to claim 6, wherein the at least one air gap comprises at least one support structure to further support the diffusion barrier layer.

8. Semiconductor device comprising a substrate according to claim 6.
